(19) United States
(12) Patent Application Publication
(10) Pub. No.: US 2012/0237302 A1
(43) Pub. Date: Sep. 20, 2012

(54) PRESSURE GAUGE ASSEMBLY FOR A RAILCAR AND METHOD OF ASSEMBLING THE SAME

(76) Inventors: Spencer Ashie-Winns, Saint Charles, MO (US); Robert John Mense, Saint Louis, MO (US); Gerald Wayne Ohmes, Wentzville, MO (US)

(21) Appl. No.: 13/049,140

(22) Filed: Mar. 16, 2011

(51) Int. Cl. B61D 7/00; B65G 51/02; G01L 13/02; B23P 11/00

(52) U.S. Cl. 406/34; 105/247; 29/428; 73/716

(57) ABSTRACT

A pressure gauge assembly for use with a railway hopper car is provided. The railway hopper car includes a railcar and a product unloading system that is attached to the railcar. The railcar includes sidewalls, end walls, and at least one bottom wall for defining an interior volume. The product unloading system includes an inlet manifold for channeling pressurized fluid to the interior volume of the railcar, and an outlet manifold for channeling the pressurized fluid to the product unloading system for discharging materials from the railcar. The pressure gauge assembly includes a housing that is attached to the railcar. A first pressure gauge is positioned within the housing. The first pressure gauge is configured to measure a differential pressure between the interior volume of the railcar and the product unloading system.

### BACKGROUND OF THE INVENTION

The embodiments described herein relate generally to a pressure gauge assembly for railcars and, more particularly, to a pressure gauge assembly for a railway hopper car that includes a differential pressure gauge for measuring a differential pressure between an internal railcar body and a product unloading system to facilitate unloading a material transported within the railcar.

Railroad cars generally have one or more compartments for storing and transporting materials. At least some known railcars include a product unloading system that pressurizes an internal volume of the railroad cars to facilitate unloading the material from the railcar. At least some known product unloading systems include an inlet manifold for channeling a pressurized fluid to the railcar, and an outlet manifold for channeling material from the railcar to a product storage unit. The product unloading systems include a pressure gauge assembly for measuring a fluid pressure within the internal volume of the railcar or the product unloading system.

At least some known product unloading systems include a first configuration of a pressure gauge assembly that includes a railcar pressure gauge for measuring air pressure within the railcar, and a manifold pressure gauge for measuring air pressure within the inlet manifold. During unloading of material from the railcar, an operator adjusts a flow of pressurized air channeled to the railcar to adjust a pressure within railcar such that the displayed railcar pressure is less than the displayed manifold pressure. The operator monitors the internal railcar pressure and the manifold pressure, calculates the difference between the internal railcar pressure and the manifold pressure, and adjusts the pressure within the railcar to within a preferred differential pressure between the railcar and the inlet manifold.

Other known product unloading systems include a second configuration of the pressure gauge assembly that includes a railcar pressure gauge and an outlet manifold pressure gauge for measuring a fluid pressure within the outlet manifold. During unloading of material using these product unloading systems, the operator adjusts the pressure within the internal volume of the railcar such that the displayed railcar pressure is greater than the displayed manifold pressure. The various configurations result in undesirable errors in adjusting the pressure within the railcar that may result in over-pressurizing or under-pressurizing the railcar during unloading.

A pressure differential gauge assembly is needed that eliminates the need for the operator to calculate the difference between the internal railcar pressure and the manifold pressure to unload material from the railcar. Specifically, a pressure differential gauge assembly is needed that facilitates measuring a pressure differential between the internal volume of the railcar and the product unloading system.

### BRIEF DESCRIPTION OF THE INVENTION

In one aspect, a pressure gauge assembly for use with a railway hopper car is provided. The railway hopper car includes a railcar and a product unloading system that is attached to the railcar. The railcar includes sidewalls, end walls, and at least one bottom wall for defining an interior volume. The product unloading system includes an inlet manifold for channeling pressurized fluid to the interior volume of the railcar, and an outlet manifold for channeling the pressurized fluid to the product unloading system for discharging materials from the railcar. The pressure gauge assembly includes a housing that is attached to the railcar. A first pressure gauge is positioned within the housing. The first pressure gauge is configured to measure a differential pressure between the interior volume of the railcar and the product unloading system.

In another aspect, a product unloading system for use with a railway hopper car is provided. The railway hopper car includes a railcar that includes sidewalls, end walls, and at least one bottom wall for defining an interior volume. The product unloading system includes an inlet manifold that is attached to the railcar for channeling pressurized fluid from a fluid supply system to the interior volume of the railcar for pressurizing the railcar. An outlet manifold is attached to the railcar for channeling the pressurized fluid to the product unloading system for directing material from the railcar to a product storage system. At least one bypass valve is attached between the inlet manifold and the outlet manifold to enable a flow of the pressurized fluid to be selectively channeled between the inlet manifold and the outlet manifold to adjust a pressure within the railcar. A pressure gauge assembly is attached in flow communication with the interior volume of the railcar and one of the inlet manifold and the outlet manifold for measuring a differential pressure between the interior volume of the railcar and the product unloading system.

In a further aspect, a method of assembling a product unloading system for use with a railway hopper car is provided. The railway hopper car includes a railcar that includes sidewalls, end walls, and at least one bottom wall for defining an interior volume. The method includes coupling an inlet manifold to the railcar for channeling pressurized fluid from a fluid supply system to the interior volume of the railcar for pressurizing the railcar. An outlet manifold is attached to the railcar for channeling the pressurized fluid to the product unloading system for directing material from the railcar to a product storage system. At least one bypass valve is attached between the inlet manifold and the outlet manifold to enable a flow of the pressurized fluid to be selectively channeled between the inlet manifold and the outlet manifold to adjust a pressure within the railcar. A pressure gauge assembly is attached to the interior volume of the railcar and to one of the inlet manifold and the outlet manifold for measuring a differential pressure between the interior volume of the railcar and the product unloading system.

In yet another aspect, a railway hopper car is provided. The railway hopper car includes a railcar that includes an upper portion that includes a first sidewall, an opposing second sidewall, a first end wall, and an opposing second end wall. A lower portion is attached to the upper portion to define an interior volume of the hopper car. A product unloading system is attached to the railcar. The product unloading system includes an inlet manifold that is attached to the railcar for channeling pressurized fluid from a fluid supply system to the interior volume of the railcar for pressurizing the railcar. An outlet manifold is attached to the railcar for channeling the pressurized fluid to the product unloading system for directing material from the railcar to a product storage system. At least one bypass valve is attached between the inlet manifold and the outlet manifold to enable a flow of the pressurized fluid to be selectively channeled between the inlet manifold and the outlet manifold to adjust a pressure within the interior volume of the railcar. The product unloading system also includes a pressure gauge assembly for measuring a differential pressure between the interior volume of the railcar and the product unloading system. The pressure gauge system includes a housing that is attached to the railcar. A first pressure gauge is positioned within the housing. The first pressure gauge is configured to measure a differential pressure between the interior volume of the railcar and the product unloading system. A second pressure gauge is positioned within the housing. The second pressure gauge is configured to measure a pressure within the interior volume of the railcar.

### BRIEF DESCRIPTION OF THE DRAWINGS

FIG. 1-6 show exemplary embodiments of the apparatus described herein.

FIG. 1 is a side view of an exemplary railway hopper car having a product unloading system in accordance with the present invention.

FIG. 2 is a schematic view of the railway hopper car shown in FIG. 1 with an exemplary embodiment of the product unloading system.

FIG. 3 is a front view of an exemplary pressure gauge assembly that may be used with the railway hopper car shown in FIG. 1.

FIG. 4 is a side-view of the pressure gauge assembly shown in FIG. 3.

FIG. 5 is an enlarged front view of the pressure gauge assembly shown in FIG. 3.

FIG. 6 is a partial cross-sectional view of the pressure gauge assembly shown in FIG. 3.

### DETAILED DESCRIPTION OF THE INVENTION

The exemplary methods and systems described herein overcome at least some disadvantages of known railroad cars by providing a product unloading system that measures a differential pressure between the internal pressures of the railroad car and the product unloading system. The methods and systems described herein enable an operator to adjust the differential pressure to within a preferred differential pressure range to facilitate efficiently unloading material from the railroad car. More specifically, the embodiments described herein provide a pressure gauge assembly that includes a pressure differential gauge that displays the preferred range of pressure differential values to efficiently unload the material from the railcar. This pressure gauge assembly allows the operator to adjust a flow of pressurized fluid (e.g., air) being channeled to the railroad car to adjust the measured differential pressure to within the preferred differential pressure range, reducing time and cost associated with unloading material and reducing damage to the railcar.

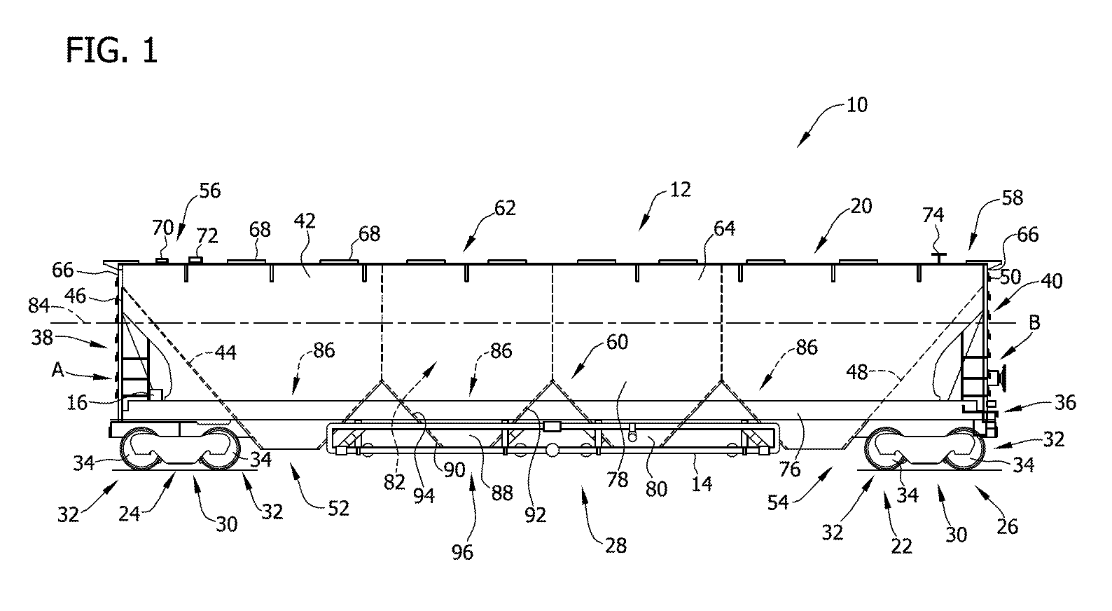

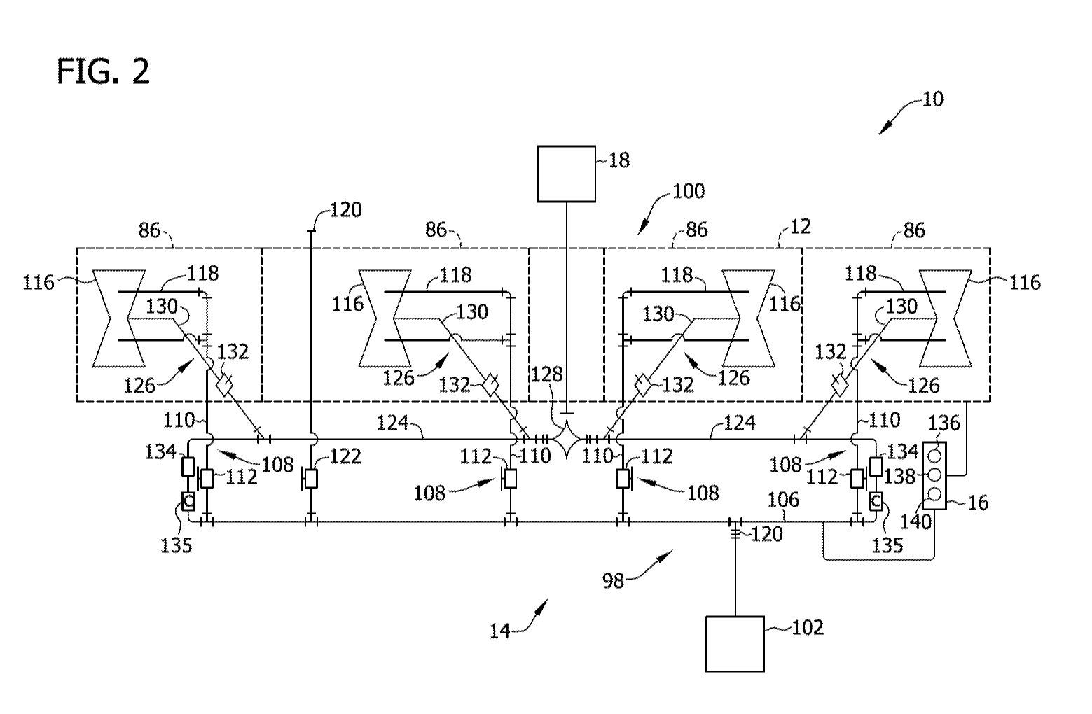

FIG. 1 is a side view of an exemplary railway hopper car 10. FIG. 2 is a schematic view of railway hopper car 10. In the exemplary embodiment, railway hopper car 10 is configured to store and/or transport materials, such as flour, starch, and/or any other granular, semi-granular, or other flowable material. In the exemplary embodiment, railway hopper car 10 includes a railcar 12, a product unloading system 14 that is coupled to railcar 12, and a pressure gauge assembly 16. Product unloading system 14 is configured to pressurize railcar 12 to facilitate unloading material transported within railway hopper car 10, and to convey the material to a product storage system 18. Pressure gauge assembly 16 is coupled to railcar 12 and product unloading system 14 for measuring a differential pressure between railcar 12 and product unloading system 14. In the exemplary embodiment, railcar 12 is configured to be pressurized up to about 14.7 pounds per square inch (psi). Alternatively, railcar 12 is configured to withstand any suitable pressure that enables railway hopper car 10 to function as described herein.

In the exemplary embodiment, railcar 12 includes an upper portion 20 that is attached to a lower portion 22. Lower portion 22 includes a front center sill assembly 24, a rear center sill assembly 26, and a cargo assembly 28 that extends between front center sill assembly 24 and rear center sill assembly 26. Each sill assembly 24 and 26 includes a truck 30 that has a pair of axles 32 that are attached to a pair of wheel sets 34. A braking system 36 is attached to rear center sill assembly 26. Upper portion 20 includes a front end structure 38, a rear end structure 40, and two opposing sidewalls 42 extending therebetween. Front end structure 38 includes a front sloped sheet 44 that is attached to a first end wall, i.e. a front end wall 46. Front sloped sheet 44 extends obliquely inwardly from front end wall 46 towards rear end structure 40. Rear end structure 40 includes a rear sloped sheet 48 that is attached to a second end wall, i.e. a rear end wall 50. Rear sloped sheet 48 extends obliquely inwardly from rear end wall 50 towards front end structure 38. Front end structure 38 is attached to front center sill assembly 24 and to a forward portion 52 of cargo assembly 28. Rear end structure 40 is attached to rear center sill assembly 26 and to a rear portion 54 of cargo assembly 28. Sidewalls 42 are attached between front end wall 46 and rear end wall 50 such that railway hopper car 10 extends between an “A” end and an opposite “B” end that includes braking system 36. A forward section 56 of sidewalls 42 is attached to front end wall 46 and to front sloped sheet 44. A rearward section 58 of sidewalls 42 is attached to rear end wall 50 and to rear sloped sheet 48. A bottom section 60 of sidewalls 42 is attached to cargo assembly 28.

A roof assembly 62 is attached to a top section 64 of sidewalls 42 such that sidewalls 42 extend between roof assembly 62 and cargo assembly 28. Roof assembly 62 is further attached to a top 66 of front end wall 46 and a top 66 of rear end wall 50. In an alternative embodiment, roof assembly 62, sidewalls 42, front end wall 46 and rear end wall 50 are formed integrally to form upper portion 20. In the exemplary embodiment, roof assembly 62 includes a plurality of roof hatches 68. Each roof hatch 68 includes a pressure tight seal to prevent contamination of materials that are transported within railcar 12. Roof assembly 62 also includes a pressure relief valve 70, a vacuum relief valve 72, and a rupture disk 74. Pressure relief valve 70 is configured to selectively discharge pressurized fluid from railcar 12 when an operating pressure within railcar 12 is greater than a predefined pressure, i.e. a rated design pressure, of railcar 12. Vacuum relief valve 72 is configured to enable air to be selectively channeled into railcar 12 when a vacuum condition exists within railcar 12. Rupture disk 74 is a fail-safe device and is configured to rupture to provide flow communication between ambient air and railcar 12 when vacuum relief valve 72 and/or pressure relief valve 70 are inoperable.

In the exemplary embodiment, at least one side sill 76 is attached to an outer surface 78 of cargo assembly 28 and an outer surface 80 of sidewalls 42. Side sill 76 extends between front end structure 38 and rear end structure 40. Sidewalls 42, roof assembly 62, and cargo assembly 28 together define an interior volume 82 extending between front end wall 46 and rear end wall 50. Interior volume 82 extends along a longitudinal axis 84 defined between front end wall 46 and rear end wall 50.

In the exemplary embodiment, cargo assembly 28 includes a plurality of cargo wells 86 that are each attached to an adjacent cargo well 86 such that cargo assembly 28 extends along longitudinal axis 84 between front end structure 38 and rear end structure 40. In the exemplary embodiment, cargo assembly 28 includes four cargo wells 86. In one embodiment, cargo assembly 28 includes three cargo wells 86. Alternatively, cargo assembly 28 may include any number of cargo wells 86 that enable railway hopper car 10 to function as described herein.

Each cargo well 86 includes two opposing side well panels 88, a front well panel 90, and a rear well panel 92. Side well panels 88 are attached between front well panel 90 and rear well panel 92 to form cargo well 86. Side well panels 88, front well panel 90, and rear well panel 92 each include an inner surface 94 that extends downwardly and/or inwardly sloping from sidewalls 42 to form cargo well 86 having a trapezoidal shape. In an alternative embodiment, cargo well 86 is formed having a conical shape. Cargo well 86 defines an opening 96 that is sized to provide access to interior volume 82 through opening 96.

In the exemplary embodiment, product unloading system 14 includes an inlet assembly 98 and an outlet assembly 100. Inlet assembly 98 is attached between a fluid distribution system 102 and railcar 12 and is configured to channel a flow of pressurized fluid from fluid distribution system 102 to railcar 12. In one embodiment, fluid distribution system 102 includes a blower that is configured to channel pressurized air to inlet assembly 98. Alternatively fluid distribution system 102 may include a pump, a compressor, a fan, and/or any other suitable device for controlling a flow of pressurized fluid. Outlet assembly 100 is attached between railcar 12 and product storage system 18 and is configured to channel materials contained within railcar 12 to product storage system 18.

In the exemplary embodiment, inlet assembly 98 includes an inlet manifold 106 and a plurality of flow control assemblies 108 that are attached between inlet manifold 106 and railcar 12. Each flow control assembly 108 is attached to a respective cargo well 86 for channeling a flow of pressurized fluid from inlet manifold 106 to cargo well 86. In the exemplary embodiment, each flow control assembly 108 includes a supply line 110 and a fluidizing valve 112. Supply line 110 is attached between inlet manifold 106 and cargo well 86. Fluidizing valve 112 is attached to supply line 110 to enable a flow of pressurized fluid to be selectively channeled from inlet manifold 106 to cargo well opening 96. Fluidizing valve 112 is selectively movable between an open position that allows pressurized air to be channeled from an interior volume of inlet manifold 106 to cargo well 86, and a closed position that prevents a flow of pressurized air to be channeled from inlet manifold 106 to cargo well 86. In the exemplary embodiment, flow control assembly 108 also includes a fluidizing pad 116 that is positioned within cargo well 86, and one or more fluidizing lines 118 that are attached between supply line 110 and fluidizing pad 116 for channeling pressurized air from supply line 110 to fluidizing pad 116. Fluidizing pad 116 is configured to discharge pressured air into railcar 12 to pressurize railcar 12 and fluidize material stored within cargo well 86 to facilitate discharging the material from cargo well 86.

In the exemplary embodiment, inlet manifold 106 includes one or more supply connectors 120 that are configured to couple inlet manifold 106 with fluid distribution system 102. Inlet assembly 98 also includes a pressure relief valve 122 that is attached to inlet manifold 106 for discharging pressurized fluid from inlet manifold 106 when an operating pressure of product unloading system 14 exceeds a predefined pressure, i.e. a rated pressure of product unloading system 14.

In the exemplary embodiment, outlet assembly 100 includes an outlet manifold 124, a plurality of product discharge assemblies 126, and a product conveyance assembly 128. Each product discharge assembly 126 is attached to a respective cargo well 86 for channeling material from cargo well 86 to outlet manifold 124. Each product discharge assembly 126 includes a discharge line 130 and a product valve 132 that is attached to discharge line 130 to enable a flow of material to be selectively channeled from cargo well 86 to outlet manifold 124. Product valve 132 is selectively movable between an open position that allows material to be channeled from cargo well 86 to outlet manifold 124, and a closed position that prevents a flow of material to be channeled from cargo well 86 to outlet manifold 124. Product conveyance assembly 128 is attached to outlet manifold 124 and is configured to channel material from an interior volume of outlet manifold 124 to product storage system 18.

In the exemplary embodiment, product unloading system 14 includes at least one bypass valve 134 that is attached between inlet manifold 106 and outlet manifold 124 to enable a flow of pressurized fluid to be selectively channeled from inlet manifold 106 to outlet manifold 124. Bypass valve 134 is selectively movable between an open position that enables a flow of pressurized fluid to be channeled from inlet manifold 106 to outlet manifold 124, a closed position that prevents a flow of pressurized fluid to be channeled from inlet manifold 106 to outlet manifold 124, and any position between the open position and the closed position to adjust a flow of pressurized fluid being channeled from inlet manifold 106 to outlet manifold 124. A check valve 135 is attached to inlet manifold 106 and is positioned between bypass valve 134 and fluid distribution system 102. Check valve 135 is configured to prevent a return flow of pressurized air from outlet manifold 124 to inlet manifold 106.

In the exemplary embodiment, pressure gauge assembly 16 is mounted railcar 12 and is positioned adjacent side sill assembly 76 and adjacent the “A” end of railcar 12. In one embodiment, pressure gauge assembly 16 is positioned adjacent to bypass valve 134 to enable an operator to monitor pressure gauge assembly 16 when operating bypass valve 134. Alternatively, pressure gauge assembly 16 is mounted at any location along railcar 12 such that pressure gauge assembly 16 is visible to an operator during operation of product unloading system 14.

In the exemplary embodiment, pressure gauge assembly 16 includes a first pressure gauge 136, i.e. a differential pressure gauge, a second pressure gauge 138, i.e. a railcar pressure gauge, and a third pressure gauge 140, i.e. a manifold pressure gauge. In an alternative embodiment, pressure gauge assembly 16 does not include manifold pressure gauge 140. In the exemplary embodiment, first pressure gauge 136 is coupled to railcar 12 and inlet manifold 106, and is configured to measure a differential pressure between a fluid pressure within inlet manifold 106 and a fluid pressure within interior volume 82 of railcar 12. Second pressure gauge 138 is coupled to railcar 12 for measuring a fluid pressure within interior volume 82. Third pressure gauge 140 is coupled to inlet manifold 106 and is configured to measure a fluid pressure within inlet manifold 106.

In an alternative embodiment, first pressure gauge 136 is attached to outlet manifold 124 and railcar 12 for measuring a differential pressure between a fluid pressure within railcar 12 and a fluid pressure within outlet manifold 124. Third pressure gauge 140 is attached to outlet manifold 124 for measuring a fluid pressure within outlet manifold 124.

During operation of product unloading system 14, fluid distribution system 102 channels a flow of pressurized fluid to the interior volume of inlet manifold 106 to pressurize inlet manifold 106 to a first fluid pressure. An operator moves fluidizing valve 112 from the closed position to the open position to pressurize railcar 12 to the first fluid pressure, and to fluidize materials contained in cargo well 86. Pressure gauge assembly 16 measures the fluid pressure within railcar 12 and displays the measured fluid pressure to the operator. In the exemplary embodiment, railcar 12 is pressurized to a first pressure that is approximately equal to about 14.5 psi. After pressurizing railcar 12 to the first fluid pressure, the operator moves product valve 132 from the closed position to the open position to enable materials to be channeled from cargo well 86 to the interior volume of outlet manifold 124. The operator selectively moves bypass valve 134 between the closed position and the open position to channel at least a portion of the pressurized fluid from inlet manifold 106 to outlet manifold 124 to reduce a pressure within railcar 12 to a second fluid pressure that is less than the first fluid pressure of inlet manifold 106. In addition, pressurized fluid channeled from inlet manifold 106 to outlet manifold 124 facilitates fluidizing material within outlet manifold 124 to discharge material through outlet manifold 124. Pressure gauge assembly 16 measures the differential pressure between the first fluid pressure within inlet manifold 106 and the second fluid pressure within interior volume 82 of railcar 12, and displays the differential pressure between railcar 12 and inlet manifold 106. The operator adjusts the bypass valve 134 between the open and closed position until the differential pressure between inlet manifold 106 and railcar 12 is within a predefined range of differential pressure values. In the exemplary embodiment, the operator adjusts bypass valve 134 until the measured differential pressure is between 0 psi and about 3 psi.

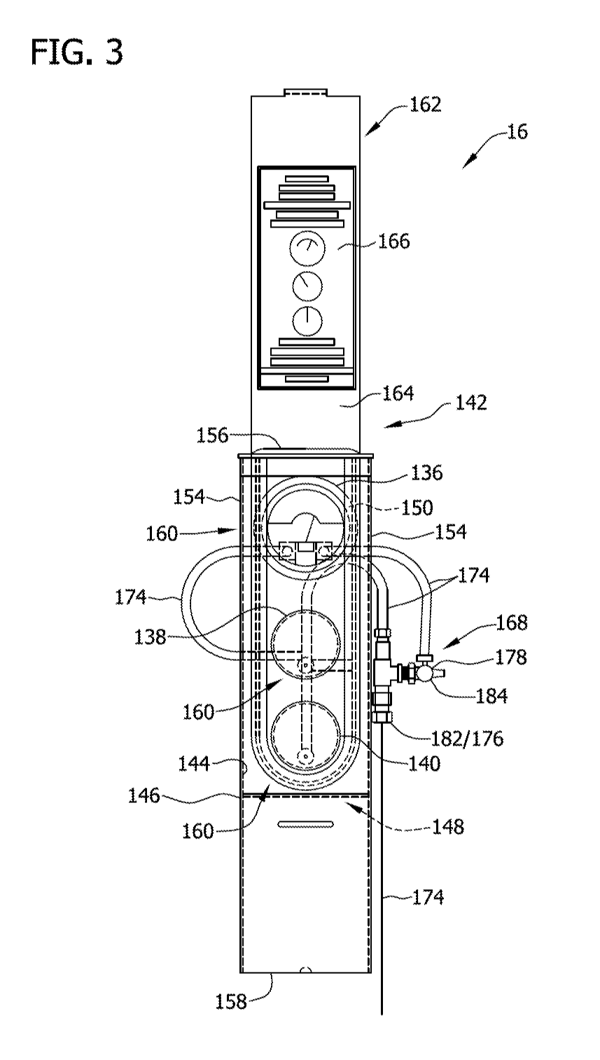

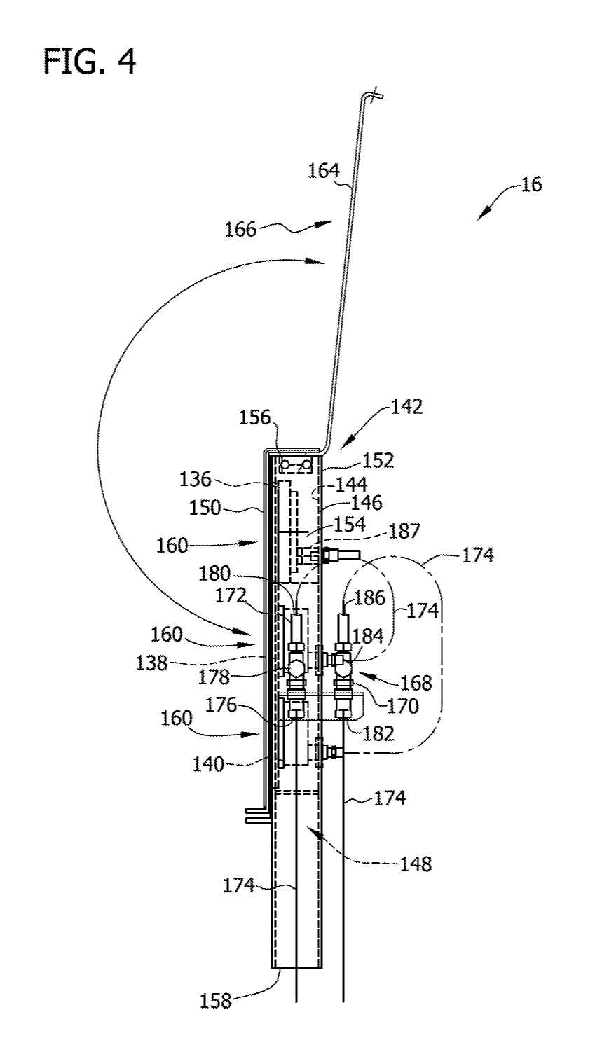

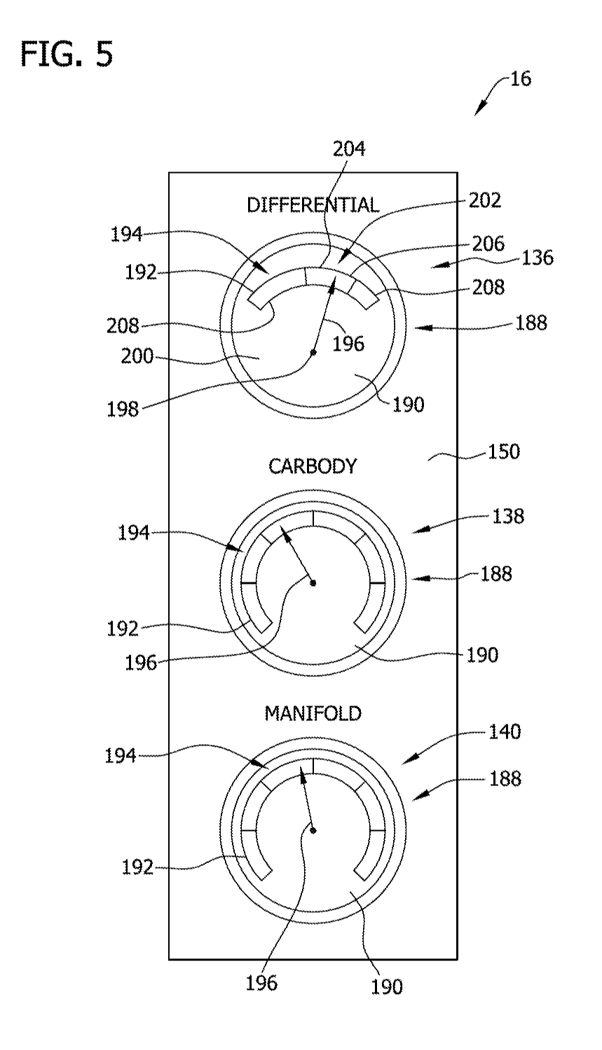

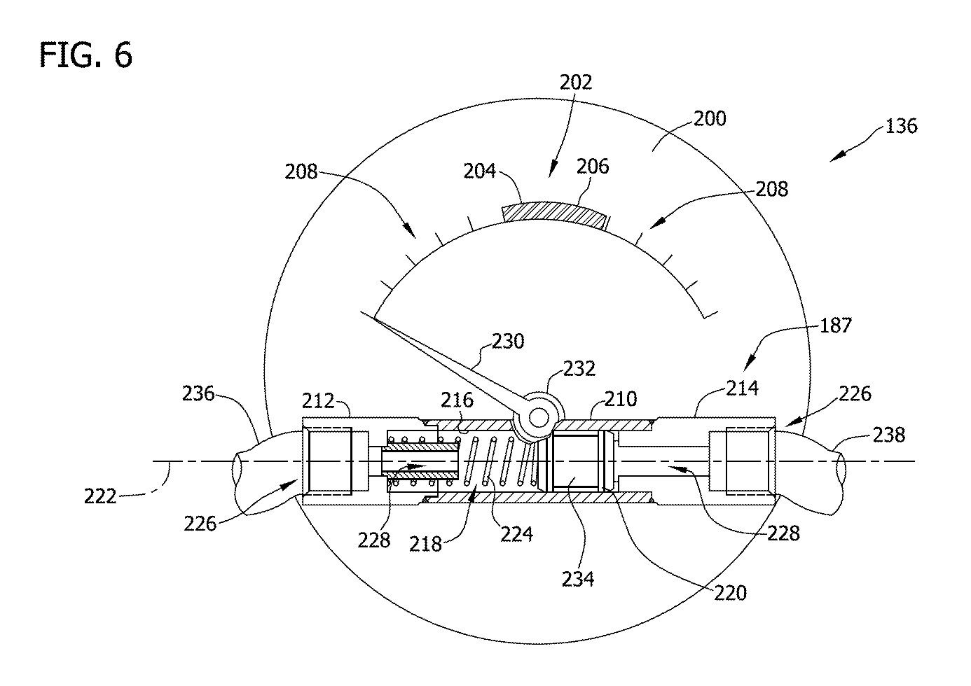

FIG. 3 is a front view of pressure gauge assembly 16. FIG. 4 is a side-view of pressure gauge assembly 16. FIG. 5 is an enlarged front view of pressure gauge assembly 16. FIG. 6 is partial cross-sectional view of pressure gauge assembly 16. In the exemplary embodiment, pressure gauge assembly 16 includes a housing 142 that includes an inner surface 144 and an outer surface 146. Inner surface 144 defines a cavity 148 that is sized to receive pressure gauges 136, 138, and 140, therein. In the exemplary embodiment, housing 142 includes a front surface 150, a rear surface 152, and two opposing sidewalls 154 that extend between front surface 150 and rear surface 152. Sidewalls 154, front surface 150, and rear surface 152 extend between a top surface 156 and a bottom surface 158 and define a substantially rectangular cavity 148. Front surface 150 defines a plurality of openings 160 that are each sized to receive a respective pressure gauge 136, 138, and 140, therein. In one embodiment, housing 142 is a weather-proof enclosure that facilitates protecting pressure gauges 136, 138, and 140, from various environmental elements, such as, for example, rain, hail, snow, and/or debris. In the exemplary embodiment, pressure gauge assembly 16 includes a cover 162 that is pivotably attached to housing 142 to selectively cover front surface 150 and pressure gauges 136, 138, and 140. In one embodiment, cover 162 is pivotably attached to top surface 156. Alternatively, cover 162 may be attached to bottom surface 158 or sidewalls 154. In the exemplary embodiment, cover 162 includes an inner surface 164 and a label 166 that is attached to inner surface 164. Label 166 includes instructions for operating product unloading system 14 and interpreting pressure measurements displayed on gauges 136, 138, and 140. In an alternative embodiment, pressure gauge assembly 16 includes a plurality of housings 142. In one embodiment, pressure gauge assembly 16 includes a first housing 142 that is sized to receive differential pressure gauge 136, and a second housing 142 that is sized to received railcar pressure gauge 138 and manifold pressure gauge 140. First housing 142 is attached to second housing 142 and is positioned above second housing 142.

In the exemplary embodiment, pressure gauge assembly 16 includes a valve assembly 168 that is attached to each gauge 136, 138, and 140 respectively, for channeling a flow of pressurized fluid from railcar 12 and product unloading system 14 to gauges 136, 138, and 140. Valve assembly 168 is attached to housing 142 and includes a manifold assembly 170, a railcar assembly 172, and a plurality of supply lines 174. Supply lines 174 are attached to valve assembly 168, railcar 12, and inlet and outlet manifolds 106 and 124 to channel pressurized fluid from railcar 12 and manifolds 106 and 124 to gauges 136, 138, and 140. Railcar assembly 172 includes an inlet 176, a first outlet 178, and a second outlet 180. Railcar inlet 176 is attached in flow communication with railcar 12 for receiving a flow of pressurized fluid from railcar 12. First railcar outlet 178 is attached in flow communication between inlet 176 and first pressure gauge 136 for channeling pressurized fluid from railcar 12 to first pressure gauge 136. Second railcar 12 outlet 180 is attached in flow communication between inlet 176 and second pressure gauge 138 for channeling pressurized fluid from railcar 12 to second pressure gauge 138.

Manifold assembly 170 includes an inlet 182, a first outlet 184, and a second outlet 186. In the exemplary embodiment, inlet 182 is attached in flow communication with inlet manifold 106 for channeling a flow of pressurized fluid from inlet manifold 106 to first and third pressure gauges 136 and 140. First manifold outlet 184 is attached in flow communication between inlet 182 and first pressure gauge 136 for channeling a flow of pressurized fluid from inlet manifold 106 to first pressure gauge 136. Second manifold outlet 186 is attached in flow communication between inlet 182 and third pressure gauge 140 for channeling fluid from inlet manifold 106 to third pressure gauge 140. In one embodiment, valve assembly 168 includes a plurality of isolation valves (not shown) that are configured to selectively isolate gauges 136, 138, and 140 from railcar 12 and product unloading system 14.

In the exemplary embodiment, each gauge 136, 138, and 140, includes a sensor assembly 187 for measuring a fluid pressure and a display assembly 188 that is attached to sensor assembly for displaying a unit of measure indicative of the measured fluid pressure. Each display assembly 188 is positioned within a respective housing opening 160 such that each display assembly 188 is visible by an operator. Each display assembly 188 includes a display face 190 that includes a label 192 having a graduated scale 194 of pressures, and a pointer 196 that is rotatably attached to display face 190 and is configured to rotate about a center point 198 to indicate a measured pressure along graduated scale 194. In one embodiment, each gauge 136, 138, and 140 displays a unit of pressure in gauge pressure (psi or psig). Alternatively, one or more gauges 136, 138, and 140 is configured to display a unit of pressure in atmospheric pressure (“psia”) or in pascal (Pa). In an alternative embodiment, display assembly 188 includes a digital display that is configured to display a digital readout of measured pressures in units of psi, psia, and/or Pa.

In the exemplary embodiment, first pressure gauge 136 includes a display assembly 200 that includes a scale 202 that displays a preferred differential pressure range 204 for discharging material from railcar 12. In the exemplary embodiment, preferred differential pressure range 204 is indicated by a bar 206 positioned within scale 202. In one embodiment, bar 206 includes a green colored bar. In the exemplary embodiment, differential pressure values that are not within preferred differential pressure range 204 are indicated with one or more bars 208 that are positioned within scale 202 and adjacent bar 206. In one embodiment, bar 208 includes a red colored bar.

In the exemplary embodiment, display assembly 200 includes graduated pressure units between a range of about −5 psi and 0 psi, and between a range of 0 psi to about +5 psi. In one embodiment, display assembly 200 includes a preferred differential pressure range 204 that is between a range of 0 psi and about +3 psi. In an alternative embodiment, display assembly 200 includes a preferred differential pressure range 204 that is between a range of about −3 psi and 0 psi.

Referring to FIG. 6, in the exemplary embodiment, sensor assembly 187 of first pressure gauge 136 includes a gauge body 210 that extends between a first endcap 212 and an opposite second endcap 214. Gauge body 210 includes an inner surface 216 that defines a cavity 218 therein. A piston 220 is positioned within cavity 218 and is configured to move axially along a centerline axis 222 defined between first endcap 212 and second endcap 214. A spring 224 is positioned within cavity 218 and between piston 220 and first endcap 212 to bias piston 220 towards second endcap 214. Each first and second endcap 212 and 214 defines an opening 226 and includes a channel 228 that provides flow communication between opening 226 and cavity 218. A pointer 230 is pivotably attached to gauge body 210 and is oriented with respect to scale 202 to indicate a differential pressure measured by first pressure gauge 136. In the exemplary embodiment, pointer 230 includes a magnetic ring 232 and piston 220 includes a magnet 234 that causes pointer 230 to pivot based on the position of piston 220 with respect to pointer 230. A first supply line 236 is attached between first endcap 212 and first railcar outlet 178 (shown in FIG. 4) for channeling a flow of pressurized fluid from railcar 12 to first endcap 212. A second supply line 238 is attached between second endcap 214 and first manifold outlet 184 (shown in FIG. 4) for channeling a flow of pressurized fluid from inlet manifold 106 to second endcap 214. As fluid is channeled into cavity 218 from first and second endcaps 212 and 214, piston 220 moves axially along centerline axis 222 and causes pointer 230 to rotate and indicate the differential pressure between railcar 12 and inlet manifold 106.

During a product unloading operation of product, an operator couples fluid distribution system 102 to inlet manifold 106. Inlet manifold 106 channels a flow of pressurized fluid from fluid distribution system 102 to interior volume 82 of railcar 12 through valve 112 to pressurize railcar 12 to a predefined pressure. An operator moves bypass valve 134 from the closed position to the open position to channel at least a portion of the pressurized fluid from inlet manifold 106 to outlet manifold 124 to reduce a pressure within inlet manifold 106 and interior volume 82 of railcar 12. Pressure gauge assembly 16 measures a differential pressure between product unloading system 14 and railcar 12. The operator adjust the pressure within the railcar 12 by adjusting a position of bypass valve 134 between the open and closed position to selectively channel a portion of the pressurized fluid from inlet manifold 106 to outlet manifold 124 until the measured differential pressure is within a predefined range of differential pressure values. After adjusting the differential pressure to within the predefined range of differential pressure values, the operator opens product valve 132 to enable the product materials to be channeled from cargo well 86 to product storage system 18. As the materials are discharged to product storage system 18, the pressure within railcar 12 is reduced. The operator monitors the differential pressure displayed by pressure gauge assembly 16 and selectively adjusts the position of bypass valve 134 such that the measured differential pressure remains within the predefined range of differential pressure values until the unloading operation is complete.

In one embodiment, first pressure gauge is attached in flow communication with an interior volume of inlet manifold 106 and interior volume 82 of railcar 12 and is configured to measure a differential pressure between inlet manifold 106 and interior volume 82 of railcar 12. The operator selectively moves bypass valve 134 between the open and closed position to adjust the pressure with railcar 12 until the measured differential pressure between railcar 12 and inlet manifold 106 is within a preferred differential pressure range between 0 psi and about +3 psi.

In an alternative embodiment, first pressure gauge is attached in flow communication with an interior volume of outlet manifold 124 and interior volume 82 of railcar 12 and is configured to measure a differential pressure between outlet manifold 124 and railcar 12. The operator selectively moves bypass valve 134 between the open and closed position to adjust the pressure with railcar 12 until the measured differential pressure between railcar 12 and outlet manifold 124 is within a preferred differential pressure range between about −3 psi and 0 psi.

The above-described embodiments facilitate assembling a railway hopper car having a product unloading system that includes a pressure gauge assembly that displays a differential pressure between the railway hopper car and the product unloading system. The above-described pressure gauge assembly is a cost effective and efficient means to assemble a railway hopper car that facilitates adjusting a flow of pressurized fluid from the product unloading system to the railway hopper car to adjust the differential pressure to within a preferred differential pressure range. The pressure gauge assembly includes a pressure differential gauge that measures the differential pressure and displays the preferred range of pressure differential values to enable an operator to adjust a flow of pressurized fluid being channeled to the railroad car to adjust the measured differential pressure to within the preferred differential pressure range. As a result, the pressure gauge assembly facilitates reducing time and cost associated with unloading material and reducing damage to the railcar.

Exemplary embodiments of a pressure gauge assembly for a railcar and method of assembling the same are described above in detail. The pressure gauge assembly and method are not limited to the specific embodiments described herein, but rather, components of apparatus and/or steps of the method may be utilized independently and separately from other components and/or steps described herein. For example, the pressure gauge assembly may also be used in combination with other railway containers and methods, and are not limited to practice with only the railway hopper car and methods as described herein. Further, the exemplary embodiment can be implemented and utilized in connection with many other product unloading system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pressure gauge assembly for use with a railway hopper car, the railway hopper car including a railcar and a product unloading system coupled to the railcar, the railcar including sidewalls, end walls, and at least one bottom wall for defining an interior volume, the product unloading system including an inlet manifold for channeling pressurized fluid to the interior volume of the railcar, and an outlet manifold for channeling the pressurized fluid to the product unloading system for discharging materials from the railcar, said pressure gauge assembly comprising:
a housing coupled to the railcar; and
a first pressure gauge positioned within said housing, said first pressure gauge configured to measure a differential pressure between the interior volume of the railcar and the product unloading system.

2. A pressure gauge assembly in accordance with claim 1, further comprising a second pressure gauge positioned within said housing, said second pressure gauge configured to measure a pressure within the interior volume of the railcar.

3. A pressure gauge assembly in accordance with claim 2, further comprising a third pressure gauge positioned within said housing, said third pressure gauge coupled to the product unloading system for measuring a pressure within the product unloading system.

4. A pressure gauge assembly in accordance with claim 2, further comprising a third pressure gauge coupled to the inlet manifold for measuring a pressure within the inlet manifold.

5. A pressure gauge assembly in accordance with claim 2, further comprising a third pressure gauge coupled to the outlet manifold for measuring a pressure within the outlet manifold.

6. A pressure gauge assembly in accordance with claim 1, wherein said first pressure gauge comprises a display assembly configured to display the measured differential pressure and display a preferred differential pressure range for discharging material from the railcar.

7. A pressure gauge assembly in accordance with claim 6, wherein the display assembly comprises a differential pressure range between about −5 psi and about +5 psi.

8. A pressure gauge assembly in accordance with claim 7, wherein said first pressure gauge is configured to measure a differential pressure between the interior volume of the railcar and the inlet manifold of the product unloading system, said display assembly comprises a preferred differential pressure range between 0 psi and about +3 psi.

9. A pressure gauge assembly in accordance with claim 7, wherein said first pressure gauge is configured to measure a differential pressure between the interior volume of the railcar and the outlet manifold of the product unloading system, said display assembly comprises a preferred differential pressure range between about −3 psi and 0 psi.

10. A pressure gauge assembly in accordance with claim 1, wherein said first pressure gauge is coupled to the inlet manifold and configured to measure a differential pressure between the inlet manifold and the railcar.

11. A pressure gauge assembly in accordance with claim 1, wherein said first pressure gauge is coupled to the outlet manifold and configured to measure a differential pressure between the outlet manifold and the railcar.

12. A product unloading system for use with a railway hopper car, the railway hopper car including a railcar including sidewalls, end walls, and at least one bottom wall for defining an interior volume, said product unloading system comprising:
an inlet manifold coupled to the railcar for channeling pressurized fluid from a fluid supply system to the interior volume of the railcar for pressurizing the railcar;
an outlet manifold coupled to the railcar for channeling the pressurized fluid to said product unloading system for directing material from the railcar to a product storage system;
at least one bypass valve coupled between said inlet manifold and said outlet manifold to enable a flow of the pressurized fluid to be selectively channeled between said inlet manifold and said outlet manifold to adjust a pressure within the railcar; and
a pressure gauge assembly coupled in flow communication with the interior volume of the railcar and one of said inlet manifold and said outlet manifold for measuring a differential pressure between the interior volume of the railcar and said product unloading system.

13. A product unloading system in accordance with claim 12, wherein said pressure gauge assembly comprises:
a housing coupled to the railcar; and
a first pressure gauge positioned within said housing, said first pressure gauge configured to measure a differential pressure between the interior volume of the railcar and the product unloading system.

14. A product unloading system in accordance with claim 13, wherein said first pressure gauge is coupled to the inlet manifold and configured to measure a differential pressure between the inlet manifold and the railcar.

15. A product unloading system in accordance with claim 13, wherein said first pressure gauge is coupled to the outlet manifold and configured to measure a differential pressure between said outlet manifold and said railcar.

16. A product unloading system in accordance with claim 13, wherein said pressure gauge assembly further comprises a second pressure gauge configured to measure a pressure within the interior volume of the railcar.

17. A product unloading system in accordance with claim 16, wherein said pressure gauge assembly further comprises a third pressure gauge coupled to said product unloading system for measuring a pressure within said product unloading system.

18. A product unloading system in accordance with claim 16, wherein said third pressure gauge is coupled to said inlet manifold for measuring a pressure within said inlet manifold.

19. A product unloading system in accordance with claim 16, wherein said third pressure gauge is coupled to said outlet manifold for measuring a pressure within said outlet manifold.

20. A product unloading system in accordance with claim 13, wherein said first pressure gauge comprises a display assembly configured to display the measured differential pressure and display a preferred differential pressure range for discharging material from the railcar.

21. A method of assembling a product unloading system for use with a railway hopper car, the railway hopper car including a railcar including sidewalls, end walls, and at least one bottom wall for defining an interior volume, said method comprising:
coupling an inlet manifold to the railcar for channeling pressurized fluid from a fluid supply system to the interior volume of the railcar for pressurizing the railcar;
coupling an outlet manifold to the railcar for channeling the pressurized fluid to the product unloading system for directing material from the railcar to a product storage system;
coupling at least one bypass valve between the inlet manifold and the outlet manifold to enable a flow of the pressurized fluid to be selectively channeled between the inlet manifold and the outlet manifold to adjust a pressure within the railcar; and
coupling a pressure gauge assembly to the interior volume of the railcar and to one of the inlet manifold and the outlet manifold for measuring a differential pressure between the interior volume of the railcar and the product unloading system.

22. A method in accordance with claim 21, further comprising coupling a first pressure gauge to the interior volume of the railcar and the inlet manifold for measuring a differential pressure between the inlet manifold and the interior volume of the railcar.

23. A method in accordance with claim 21, further comprising coupling a first pressure gauge to the interior volume of the railcar and the outlet manifold for measuring a differential pressure between the outlet manifold and the railcar.

24. A method in accordance with claim 23, further comprising coupling a second pressure gauge to the interior volume of the railcar for measuring a pressure within the railcar.

25. A railway hopper car comprising:
a railcar comprising:
an upper portion comprising a first sidewall, an opposing second sidewall, a first end wall, and an opposing second end wall; and
a lower portion coupled to said upper portion to define an interior volume of said hopper car; and
a product unloading system coupled to said railcar, said product unloading system comprising:
an inlet manifold coupled to said railcar for channeling pressurized fluid from a fluid supply system to the interior volume of said railcar for pressurizing said railcar;
an outlet manifold coupled to said railcar for channeling the pressurized fluid to said product unloading system for directing material from said railcar to a product storage system;
at least one bypass valve coupled between said inlet manifold and said outlet manifold to enable a flow of the pressurized fluid to be selectively channeled between said inlet manifold and said outlet manifold to adjust a pressure within the interior volume of said railcar; and
a pressure gauge assembly for measuring a differential pressure between the interior volume of said railcar and said product unloading system, said pressure gauge system comprising:
a housing coupled to said railcar;
a first pressure gauge positioned within said housing, said first pressure gauge configured to measure a differential pressure between the interior volume of said railcar and said product unloading system; and
a second pressure gauge positioned within said housing, said second pressure gauge configured to measure a pressure within the interior volume of said railcar.
